(19) United States
(12) Patent Application Publication
(10) Pub. No.: US 2013/0047731 A1
(43) Pub. Date: Feb. 28, 2013

(54) LASER GENERATION OF NARROWBAND LAMB WAVES

(71) Applicants: Ifeanyi Charles UME, Atlanta, GA (US); Tsun-Yen WU, Atlanta, GA (US)

(72) Inventors: Ifeanyi Charles UME, Atlanta, GA (US); Tsun-Yen WU, Atlanta, GA (US)

(73) Assignee: Georgia Tech Research Corporation, Atlanta, GA (US)

(21) Appl. No.: 13/221,740

(22) Filed: Aug. 30, 2011

(51) Int. Cl. G01N 29/04

(52) U.S. Cl. 73/643

(57) ABSTRACT

A system and method for providing laser generated ultrasound technique utilizing superimposed line sources is presented. The system and method can generate narrowband Lamb waves with a dominant wavelength by superimposing signals of line sources at the pitch corresponding to the desired wavelength. The superposition can be performed in software after data are collected to permit flexibility in the wavelength selected. Selecting the dominant wavelength in signals can reduce signal complexity and the speeds and frequencies of wave modes with the selected wavelength can be determined through dispersion curves. One or more additional techniques including, but not limited to, two-dimensional Fourier transforms and wavelet analysis can be used to further reduce the complexity of the signals. The system and method can be used, for example, for defect detection in thin plates.

### BACKGROUND OF THE INVENTION

1. Field of the Invention

Embodiments of the present invention relates to a system and method for generating narrowband Lamb waves for use in, for example and not limitation, non-destructive testing. Specifically, embodiments of the present invention relate to the non-contact generation of Lamb waves in thin plates using laser beams and software analysis to detect defects.

2. Background of Related Art

It is desirable to perform non-destructive testing (“NDT”) on a variety of materials to detect and locate, for example and not limitation, material defects, manufacturing defects, and weld quality. As a result, considerable resources have been invested to develop NDT methods such as, ultrasonic inspection, radiography, thermography, and eddy current inspection.

Ultrasonic inspection techniques have gained greater acceptance for a variety of purposes in recent years. It is one of the major techniques used, for example, for inspection of welds in structures. Conventionally, contact piezoelectric transducers (PZTs) have been used to generate and receive ultrasounds during offline, as opposed to real-time, sample inspection. Due to the need for liquid couplants between the PZTs and the sample, however, this method is not suitable for automated real-time inspection during manufacture.

Non-contact ultrasonic sensing, on the other hand, has the potential to detect defects and discontinuities in real time. Using laser generated ultrasounds and an electromagnetic acoustic transducer (EMAT) receiver, for example, is one method suitable for both offline and real-time sample quality monitoring. Nanosecond pulse width lasers such as, for example, Q-switched Nd:YAG lasers can be used to generate ultrasound.

In use, a high energy, very short duration pulse from the laser induces a rapid increase in the local temperature of the sample. The heated region expands thermoelastically and then slowly contracts when the laser pulse is momentarily shut off. The rapid expansion and slower contraction creates ultrasounds which propagate through the sample. In addition to the thermoelastic effect, ablation can occur if the energy of the laser pulse is increased to the point that some portion of the surface evaporates. The ultrasounds generated in the ablation regime are much stronger than those generated in the thermoelastic regime, though the latter is generally preferred for true NDT.

Conventionally, a laser or a laser phased array system has been used to generate ultrasounds (i.e., bulk waves) to measure various characteristics in thick structures (e.g., weld penetration). A Time of flight diffraction (TOFD) technique can be used to evaluate, for example, material defects or weld characteristics. By measuring the arrival time of an ultrasonic signal, for example, various characteristics of weld such a penetration depth can be measured.

When the thickness of the sample approaches the wavelength of the ultrasonic wave, however, this method no longer provides accurate data. For thin materials, ultrasonic waves give way to Lamb waves, which exhibit very different characteristics compared to the bulk waves that travel in thick structures. Lamb waves travel through the cross section of the structure, are dispersive, and their traveling speeds are dependent on their frequencies. Lamb waves are widely used in structural integrity inspection and defect detection in thin structures because of their potentials to inspect large area and their sensitivity to a variety of damage types.

The use of lasers to generate Lamb waves is beneficial due to its noncontact nature. Laser generated ultrasound is broadband in nature, however, and this, combined with the dispersive nature of Lamb waves, makes signal processing complicated. To simplify signal processing in thin structures, therefore, narrowband Lamb waves are desirable.

Conventionally, this has been achieved using spatial array illumination sources produced by, for example, shadow masks, optical diffraction gratings, multiple lasers, interference patterns, and lenticular arrays. Shadow masks, depicted in FIG. 2a, are economical, fairly effective and easy to implement (hereinafter referred to as “pattern source”), but they are not flexible and have several disadvantages. These include, but are not limited to, the need to fabricate different masks for each different wavelength of interest, the absorption of a substantial amount of energy by the mask, and the inability to practically manufacture masks with very small spacing. In addition, because the masks must be manually changed for each separate wavelength, experimental setup for masks for a large number of wavelengths can be impractical.

What is needed, therefore, is a system and method for efficiently creating narrowband Lamb waves using one or more laser sources. The system and method should retain the non-contact benefits of conventional pattern source methods, but provide improved flexibility and efficiency. It is to such a system and method that embodiments of the present invention are primarily directed.

### BRIEF SUMMARY OF THE INVENTION

Embodiments of the present invention can comprise a system and method for providing laser generated, narrowband Lamb waves utilizing various techniques, including, but not limited to, superimposed line sources, Fourier transforms, and wavelet transforms. The system and method can generate narrowband Lamb waves with a dominant wavelength by superimposing signals of line sources at the pitch corresponding to the desired wavelength. The superposition can be performed in software after data are collected to permit flexibility in the wavelength selection. Selecting the dominant wavelength in signals can reduce signal complexity and the speeds and frequencies of wave modes with the selected wavelength can be determined using dispersion curves. One or more additional techniques can be used to further reduce the complexity of the signals. The system and method can be used, for example, for defect detection in thin plates.

Embodiments of the present invention can comprise, for example, a system for generating narrow band Lamb waves in a sample. The system can comprise a concentrated energy source, such as a pulse laser, for creating localized heating in the sample. The localized heating (and cooling) from the pulse laser can cause ultrasonic waves in the sample. An ultrasound receiver, such as, for example and not limitation, an electromagnetic acoustic transducer, can be used to detect the ultrasonic waves. In some embodiments, after each laser firing a linear stage can move the sample a first predetermined distance. The predetermined distance is preferably smaller than a desired wavelength for analysis. In some embodiments, the predetermined distance can be decided by the minimum difference between the wavelengths of interest. In some embodiments, a computer readable medium can be used to store one or more signals generated by the ultrasound receiver.

In some embodiments, the concentrated energy source can be fired through a cylindrical lens to convert the concentrated energy from the pulsed width laser to a line source pattern. In a preferred embodiment, a lens, such as, for example and not limitation, a concave lens, can be provided to make the laser beam collimated. The system can further comprise a computer processor for superimposing the one or more signals received by the ultrasound receiver to reduce the complexity of the signals. In some embodiments, the computer processor can further reduce the complexity of the signals using, for example, a two-dimensional Fourier transform or a complex Morlet mother wavelet.

Embodiments of the present invention can also comprise a method for generating narrow band Lamb waves in a sample. The method can comprise (1) activating a pulsed, concentrated energy source to create ultrasonic waves in the sample; (2) receiving the ultrasound waves with an ultrasound receiver; (3) storing the signal generated by the ultrasound receiver on a computer readable medium; (4) moving the sample a first predetermined distance; and repeating steps 1-4 until the sample has moved a second predetermined distance. In some embodiments, the method can further comprise retrieving the signals stored on the computer readable medium and superimposing the signals that correspond to a first wavelength to create an artificial pattern source. The artificial pattern source can also be stored on the computer readable medium. In some embodiments, the method can further comprise retrieving the artificial pattern source from the computer readable medium and reducing the complexity of the pattern source using a two-dimensional Fourier transform. The simplified pattern source can also be stored on the computer readable medium. In some embodiments, the method can further comprise retrieving the artificial pattern source from the computer readable medium and reducing the complexity of the pattern source using a complex Morlet mother wavelet. In other embodiments, other types of wavelet analysis, including but not limited to, other mother wavelets can be used.

These and other objects, features and advantages of the present invention will become more apparent upon reading the following specification in conjunction with the accompanying drawing figures.

### BRIEF DESCRIPTION OF THE DRAWINGS

FIG. 1a is a graph depicting the relationship between phase velocity and frequency for multiple modes of antisymmetric and symmetric Lamb wave modes.

FIG. 1b is a graph depicting the relationship between group velocity and frequency for multiple modes of antisymmetric and symmetric Lamb wave modes.

FIG. 2a depicts an experimental setup for a conventional pattern source configuration for inducing ultrasonic waves in a sample.

FIG. 2b depicts an experimental setup for a line source configuration for inducing ultrasonic waves in a sample, in accordance with some embodiments of the present invention.

FIG. 3a is a graph depicting a plurality signals generated at multiple intervals along the sample, in accordance with some embodiments of the present invention.

FIG. 3b is a graph comparing signals generated using embodiments of the present invention with signals generated using a conventional pattern source.

FIG. 4 depicts another experimental setup for a line source configuration for inducing ultrasonic waves in a sample with a defect, in accordance with some embodiments of the present invention.

FIGS. 5a-5d depict wave forms of decreasing complexity as they are processed using embodiments of the present invention.

FIG. 6 depicts wave forms that have been simplified using a two-dimensional Fourier transform, in accordance with some embodiments of the present invention.

FIGS. 7a and 7b compare graphs representing symmetric and antisymmetric mode signals interpreted in the time-amplitude and time-frequency, respectively, in accordance with some embodiments of the present invention.

FIG. 8 depicts yet another experimental setup for a line source configuration for inducing ultrasonic waves in a sample with a defect, in accordance with some embodiments of the present invention.

FIGS. 9a-9d depict simulated results for the incident and reflected symmetric and antisymmetric modes, in accordance with some embodiments of the present invention.

FIGS. 10a-10d compare simulated results with experimental results produced using embodiments of the present invention.

### DETAILED DESCRIPTION OF THE INVENTION

Embodiments of the present invention relate generally to a system for generating narrowband Lamb waves using one or more lasers, and specifically to a system and method for generating narrowband Lamb waves in thin materials for conducting non-destructive testing (“NDT”) and analysis. The system improves upon conventional methods by providing, among other things, additional energy efficiency and wavelength flexibility. The system can use one or more lasers to generate broadband waves in the sample material. The signals generated therefrom can be processed to simplify and isolate the desired wavelengths to determine their speed and frequency. The knowledge of speeds and frequencies of narrowband Lamb wave modes permits identification and time-of-flight analysis of each Lamb wave mode in applications.

To simplify and clarify explanation, the system is described below as a system for NDT and analysis of thin plates. One skilled in the art will recognize, however, that the invention is not so limited. The system can also be deployed for NDT and analysis in, for example, thick plates or where large area analysis provided by Lamb waves is desirable. The ability of Lamb waves to travel long distances can be useful to enable the NDT of large areas to improve production speeds and reduce cost. The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed, for example, after the time of the development of the invention. Any dimensions listed in the various drawings are for illustrative purposes only and are not intended to be limiting. Other dimensions and proportions are contemplated and intended to be included within the scope of the invention.

As mentioned above, several problems exist with laser generated ultrasound generated using conventional techniques, such as the shadow mask technique. Problems include, but are not limited to, loss of laser energy at the mask, difficulty in manufacturing the masks, and difficulty in changing the masks during use. These line sources nonetheless provided several advantages such as, for example and not limitation, enabling non-contact generation of ultrasonic waves. Non-contact testing can enable, for example, real-time NDT of materials during manufacture. Real-time NDT can, for example, quickly identify material flaws to enable manufacturing adjustments to be made in a timely manner, which can reduce downtime, increase production, and reduce material waste and cost.

To this end, embodiments of the present invention can comprise a method utilizing superimposed line sources (SLS). The method can generate narrowband Lamb waves with a dominant wavelength by superimposing signals from line sources at a pitch corresponding to a desired wavelength. The superposition can be performed in software so that the desired wavelength can be selected after testing. By selecting the dominant wavelength in the signals, the complexity of laser generated broadband signals can be greatly reduced and the speeds and frequencies of traveling ultrasounds at the selected wavelength can be easily determined using standard dispersion curves (i.e., graphs that show relationships between wave velocity, wavelength, and frequency in dispersive systems). The knowledge of speeds and frequencies of narrowband Lamb wave can enable the identification and time-of-flight analysis for each Lamb wave mode.

After narrowband Lamb waves have been created using SLS, a signal processing procedure that can include wavenumber-frequency (k-ω) domain filtering and continuous wavelet transform (CWT), which can be used to help identify wave packets of the zero order anti-symmetric mode (“A₀”) and the zero order symmetrical mode (“S₀”) Lamb wave modes. This, in turn, can be used to identify, for example and not limitation, the location of a material defect in a sample.

### Laser Generation of Ultrasound

As mentioned above, the use of pulsed lasers to generate ultrasound is useful because of its noncontact nature. Unlike traditional contact piezoelectric transducers (PZTs), for example, laser generation does not require couplants on the surfaces of samples. This makes it suitable for use in, for example, automated inspection during production. When the laser irradiates the surface of the sample, the high energy and short duration of each pulse induces a quick increase in local temperature. The heated region thermoelastically expands and then slowly contracts when the laser is switched off. The rapid expansion and slower contraction create broadband ultrasound waves propagating in the sample.

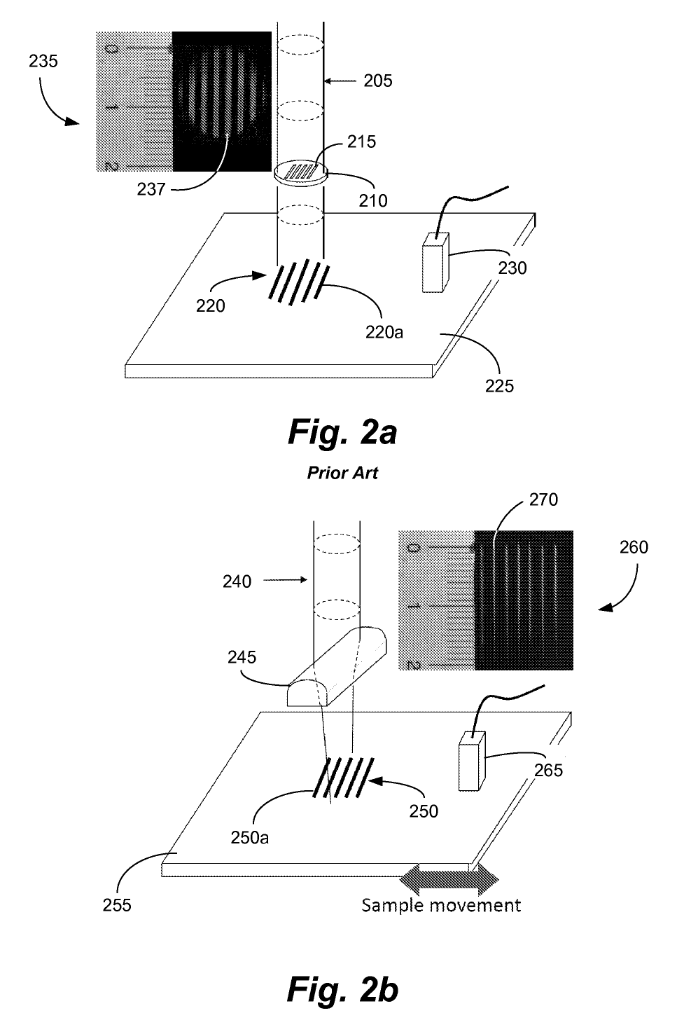

As shown in FIG. 2b, a laser beam can be directed through a cylindrical lens to form a line source that illuminates the surface of the sample and generates ultrasonic waves. In a preferred embodiment, a lens, or a set of lenses, can be used to collimate the laser beam before it is focused. Collimating the beam is not strictly necessary; however, as the laser beam can nonetheless be focused into a line source with the proper tool (e.g., a shadow mask). The laser can be any suitable laser such as, for example, a Continuum Lasers Inlite II-20 pulsed Nd:YAG laser. In other embodiments, other non-contact energy sources such as, for example and not limitation, an EMAT (electromagnetic acoustic transducer) can be used to generate ultrasounds.

The laser can produce a pulsed output at a suitable frequency. In some embodiments, the laser can be operated such that the material stays within the thermoplastic regime to prevent damage to the sample. In other embodiments, such as when a stronger ultrasonic signal is required (e.g., for larger samples) a higher energy beam can be used, though some ablation may occur. To provide NDT for thin plates, for example, a preferred embodiment of the laser can produce a firing repetition rate of approximately 20 Hz and a firing energy of approximately 46 mJ per pulse. In other embodiments, lasers with higher frequencies can be chosen for improved resolution, but these lasers generally increase cost. The energy level can be chosen to stay within the thermoplastic regime, or can be increased to enter the ablation regime. This decision is material and application specific.

The waves induced in the sample by the laser can be received using, for example and not limitation, comb transducers, wedges, waves from liquid media, and electromagnetic acoustic transducers (hereinafter, “EMAT” or “sensor”). In a preferred embodiment, an EMAT with a suitable bandwidth based on the sample size and predicted operating frequencies can be used. To provide NDT for thin plates, for example, a preferred embodiment of the EMAT can have a bandwidth of approximately 500 Hz to 2.5 MHz. Of course, different materials, material thicknesses, and other parameters could dictate the use of an EMAT with a different bandwidth. The data received by the EMAT can be gathered using an appropriate data acquisition system.

### Frequency and Traveling Speed Evaluation of Narrowband Lamb Waves

The theory and application of Lamb waves is known in the art. A key characteristic of Lamb waves is their dispersive nature. One consequence of this dispersive nature is that their phase and group velocities vary with frequency. Because laser generated ultrasound is broadband in nature for a given mode, therefore, different frequency components travel at different speeds and thus, interfere and present an obstacle to signal interpretation. This problem can be addressed by generating narrowband Lamb waves with a fixed wavelength, however, that contain a dominant frequency, which can enable the traveling speeds of different modes to be determined from standard dispersion curves.

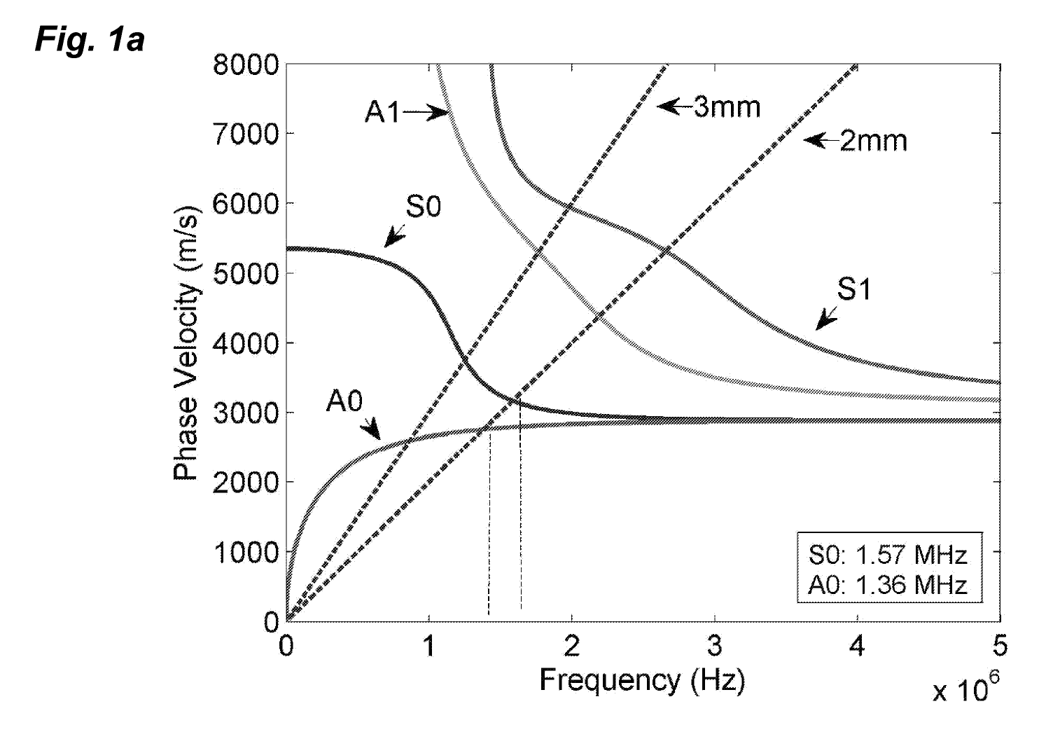

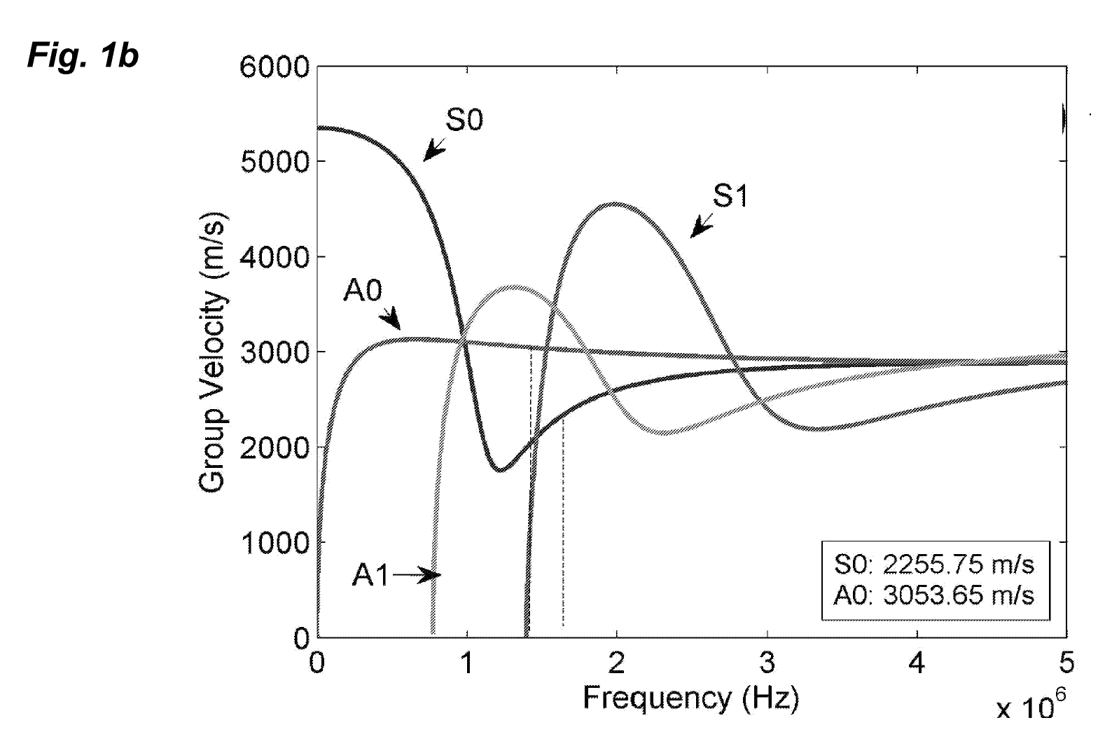

FIG. 1a shows the dispersion curves of phase velocity, Cₚ, versus frequency in a 2 mm aluminum plate. In the graph, wavelengths can be represented as straight lines passing through the origin with a slope equal to the wavelengths. If the wavelength of the narrowband Lamb waves can be pre-determined, the frequency content of each mode can be determined by the x-coordinate of the intersection between the line and the dispersion curves.

In FIG. 1a, for example, the x coordinate of the intersection between the straight line of 2 mm wavelength and S₀ dispersion curve is at approximately 1.57 MHz and approximately 1.36 MHz for A₀ mode. Once the dominant frequency of each mode is determined, the traveling speed can be determined by dispersion curves of group velocity versus frequency as shown in FIG. 1b in which, the traveling speeds (“C_{g}”) of S₀ and A₀ modes are 2255.75 and 3053.65 m/s respectively. Table 1, below, summarizes the frequencies and wave speeds of S₀ and A₀ modes with different wavelengths and plate thicknesses.

TABLE 1
Frequency Contents and Traveling Speeds of Lamb Modes

| | Plate thickness = 1.5 mm | | | | Plate thickness = 2.0 mm | | | |
|---|---|---|---|---|---|---|---|---|
| | [symbol] = 2 mm | | [symbol] = 3 mm | | [symbol] = 2 mm | | [symbol] = 3 mm | |
| Mode | Frequency (MHz) | C [symbol] (m/s) | Frequency (MHz) | C [symbol] (m/s) | Frequency (MHz) | C₈ (m/s) | Frequency (MHz) | C₈ (m/s) |
| [symbol] 0 | [symbol] | 1861.12 | [symbol] | 2080.02 | 1.57 | [symbol] | [symbol] | 1777.90 |
| [symbol] 0 | 1.56 | 3078.50 | [symbol] | 3125.00 | [symbol] | [symbol] | 0.85 | 3118.65 |

[symbol]

indicates data missing or illegible when filed

### Superimposed Line Sources (SLS)

Conventionally, as shown in FIG. 2a, narrowband laser generated ultrasound has been created using a pattern source. To create a pattern source, the laser beam 205 is first expanded and collimated and the beam 205 goes through a shadow mask 210 with slits 215. The obvious result is that a portion of the laser beam 205 passes through the slits 215 and the remainder is blocked (reflected or absorbed) by the mask 210. The effect of the generated pattern source 220 can be treated as independent line sources 220a illuminating on the surface of the sample 225 simultaneously. Because of constructive interference over the space, narrowband ultrasound with the designated wavelength can created, as determined by the spacing of the mask 210. The resulting narrowband signal can be captured by a sensor 230 (e.g., an EMAT). It should be noted, however, that the portion of the laser energy that is blocked by the mask 210 is wasted resulting in dimmer, less focused pattern sources 237, as illustrated by the laser alignment paper 235.

In contrast, using SLS, as shown in FIG. 2b, the laser beam 240 is focused by a cylindrical lens 245 to create a laser line source pattern 250. Again, the effect of the generated pattern source 250 can be treated as independent line sources 250a illuminating on the surface of the sample 225 simultaneously. In this configuration, substantially all (other than some possible diffraction in the lens) of the laser beam 240 energy is transmitted to the sample 255 and, as shown on the laser alignment paper 260. A brighter, more focused line source 270 is created. The stronger line pattern 250 results in a stronger, more coherent ultrasonic signal in the sample 255. The ultrasonic signal induced by each line source 250a is acquired by the sensor 265 and stored in computer memory individually. As discussed below, narrowband signals of a particular wavelength can then be superimposed using, for example, software to amplify signals of a desired frequency and reduce signal complexity.

### Example 1

To compare the efficacy of the SLS method versus the conventional pattern source method two preliminary experiments were conducted on a 300×200×2 mm aluminum plate. FIGS. 2a and 2b show the schematic of the experiment and the placement of the sensors and the sources for the conventional pattern source (FIG. 2a) and the SLS (FIG. 2b), respectively. FIG. 2a depicts the experiment using a pattern source 220 where the laser beam 205 goes through a mask 210 with eight slits 215. Each slit 215 is 1 mm wide and 15 mm long and the pitch between slits 215 is 2 mm. Also shown is a laser mark 237 of the pattern source 220 on the laser alignment paper 235. The width of each stripe is about 1 mm and the pitch is 2 mm.

FIG. 2b shows the experiment using SLS where the laser beam 240 goes through a cylindrical lens 245 and the beam 240 is focused into a line source 250. Laser marks with 2 mm pitch are shown on laser alignment paper 260. Compared with the lines 237 in FIG. 2a, the laser energy is clearly more focused and each line 270 is much narrower than the stripe of the pattern source 220. The signal induced by the line source 250 is then acquired by the EMAT 265.

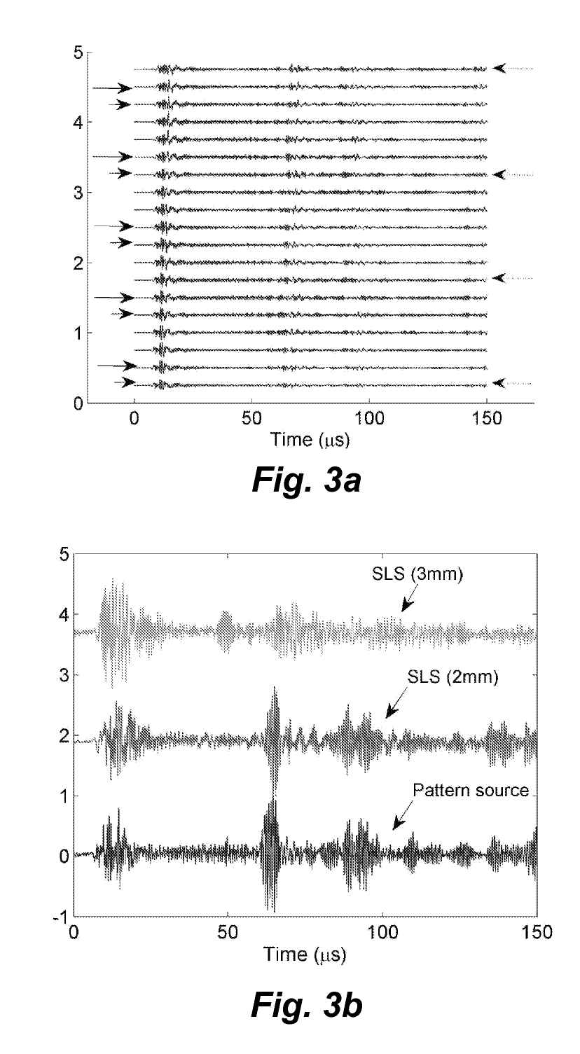

After signal acquisition in the initial position, a motorized linear stage moves the sample 255 and the EMAT 265 in 0.5 mm increments while the laser source 250 is fixed and signals induced by separate line sources 250a are acquired. The increment used for sampling is preferably chosen to be smaller than the desired wavelength and can be chosen to balance the cost and time necessary to conduct the measurements with the necessary or desired resolution. In other words, more samples may provide more or better information, but this must be balanced against the time and expense of taking same. An example of acquired signals is shown in FIG. 3a where a signal is generated at each 0.5 mm increment. By superimposing signals generated at the pitch corresponding to the desired wavelength, an artificial pattern source can be created. The superposition of signals pointed to by the dashed arrows to the right of the graph, for example, correspond to a 3 mm artificial pattern source. The short solid arrows on the left side of the graph correspond to a 2 mm source. Similarly, the long solid arrows on the left side of the graph indicate another 2 mm source, but shifted by 0.5 mm (five signals are superimposed together).

The signals corresponding to each pattern source can be superimposed (i.e., summed) to produce amplified signals. FIG. 3b depicts examples of signals from a conventional 2 mm pattern source (bottom), a 2 mm SLS source (middle) and a 3 mm SLS source (top) in the time domain. To enable comparison, for the pattern source, the distance between the source (i.e., the middle of the pattern) and the receiver is approximately 30 mm and, for the SLS, the seven signals that are superimposed are chosen so that the middle signal is also approximately 30 mm away from the receiver. In FIG. 3b, the signals are normalized with their own maxima. As shown in the figure, the signals corresponding to 2 mm produced by the SLS technique are very similar to those produced by the conventional pattern source.

### Mathematical Equivalence

The SLS technique can also be shown to be mathematically equivalent to the conventional pattern source technique given some assumptions. Assume, for example, that the response of the wave field for a single line source 220a is h(x,t), and the pattern source 220 is made of perfect line sources 220a and linearity holds. In the following equations, x denotes the distance between the point of interest on the sample 225 and the first line source 220a (it can be positive or negative depending on the signs of the coordinate system) and t denotes time. The response of the wave field of the pattern source 220 can be expressed as a convolution sum in space and the mathematical expression is shown in Eq. 1:

f(x,t)=h(x,t)*g(x) (1)

where f(x,t) is the response of the pattern source 220 and h(x,t) is the response of a single line source 220a and g(x) is the input sequence for a pattern source 220 which can be expressed as multiple Dirac delta impulses that are separated by the distance corresponding to the wavelength as in Eq. 2.

$$g ( x ) = {\sum }_{i = 0}^{n} δ ( x - i λ ) \qquad ( 2 )$$

where δ is the distance between line sources 220a and it corresponds to the desired wavelength to be generated, n stands for the total number of line sources 220a that constitute the pattern source 220, and i is the index of the line source 220. When i is zero, it denotes the first line source 220a. Substitute Eq. 2 into Eq. 1 and the response of the pattern source 220 can be derived. The derivation of the convolution is shown in Eq. 4:

$$f ( x , t ) = {\sum }_{ξ = - ∞}^{∞} h ( x - ξ , t ) g ( ξ ) = {\sum }_{ξ = - ∞}^{∞} h ( x - ξ , t ) ( {\sum }_{i = 0}^{n} δ ( ξ - i λ ) ) \qquad ( 3 )$$

Since the first term is independent of i, the summation over i can be moved to the front and the order of two summations can be interchanged. Eq. 3 becomes Eq. 4.

$${\sum }_{i = 0}^{n} {\sum }_{ξ = - ∞}^{∞} h ( x - ξ , t ) δ ( ξ - i λ ) = {\sum }_{i = 0}^{n} h ( x - i λ , t ) \qquad ( 4 )$$

Eq. 3 and Eq. 4 show that the wave field of a pattern source 220 that consists of n+1 line sources 220a, with a pitch of δ, is actually the superposition of n+1 shifted replicates of the wave field of a single laser line source 220a and the interval between each replicate is the wavelength. It should be noted that the superposition can be performed after all signals have been stored in the computer memory, which enables later wavelength selection and processing.

### Signal Processing Procedure

Embodiments of the present invention can further comprise a signal processing method. The signal processing method can include multiple parts including, but not limited to, (1) wavenumber-frequency (k-ω) domain filtering and (2) continuous wavelet transforms. An objective of this method is to reduce the complexity of signals and to identify originations of wave packets so as to facilitate the calculation of reflection coefficients resulting from the presence of one or more defects.

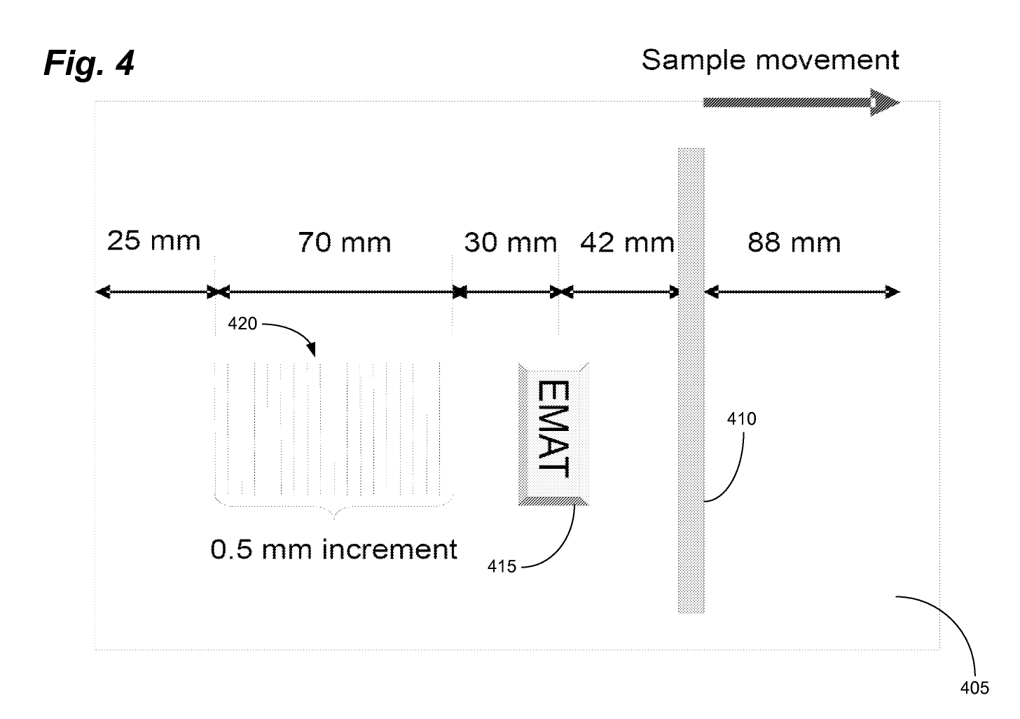

To illustrate the signal processing procedure, an experiment as depicted in FIG. 4 can be conducted on a 2 mm aluminum plate 405. The plate 405 is held on a motor driven linear stage and a laser line source 420 is used to generate ultrasounds. On the sample 405, there is an artificial groove 410 which is 0.8 mm wide and 1.75 mm deep. When conducting the experiments, the laser beam is fixed and the sample 405 and the EMAT 415 are moved by the linear stage at 0.5 mm increments. At each location, 32 signals are acquired and averaged to increase signal-to-noise ratio. After all ultrasonic signals have been stored into computer memory, the superimposed laser sources are generated by superimposing every five signals corresponding to 2 mm wavelength together.

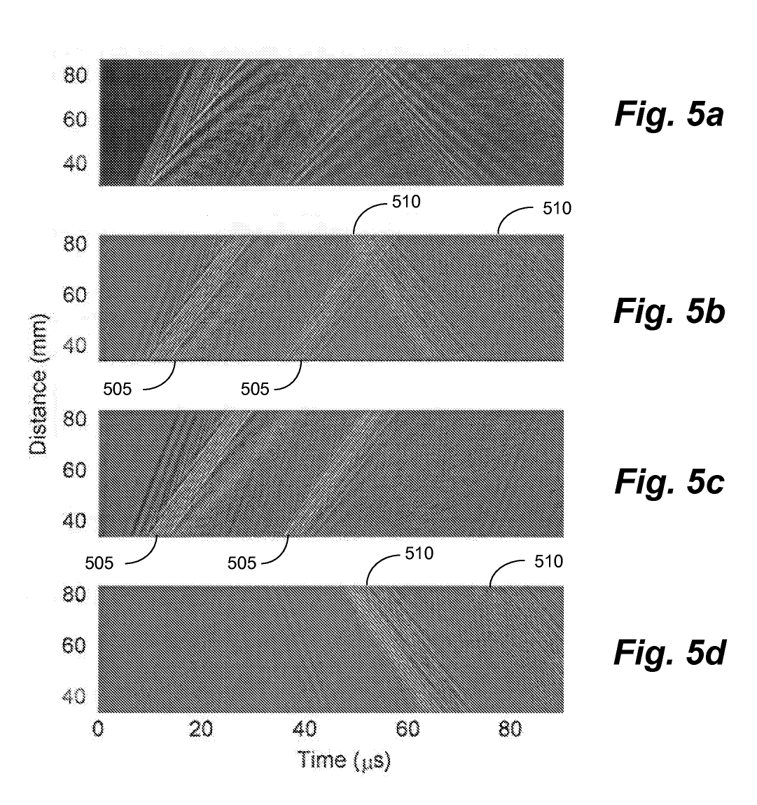

FIG. 5a shows the scan of the original signals, where the X axis denotes time and the Y axis denotes the distance between laser line sources 420 and the EMAT 425. As shown, without superimposition of the signals, considerable complexity exists making the graph difficult to interpret. FIG. 5b, on the other hand, shows the results of the SLS technique. The gray scale of the plots represents relative signal amplitude; although, the contrast and brightness are adjusted for the clarity of the plots. There are some wave fronts featuring positive slopes 505 and some featuring negative slopes 510 indicating waves with increasing or decreasing distance of travel, respectively, as the laser source 420 is moved away from the defect 410 and the EMAT 415.

The signals can be further simplified using additional techniques. The two-dimensional Fourier transform (2D FT) method, for example, is known in the art. It is widely used, for example, to measure the dispersion curves of Lamb waves and can be used to identify and measure the amplitudes of individual Lamb modes. It is also a critical step in wavenumber-frequency domain filtering technique. When full wavefield measurements are transformed into wavenumber and frequency domain by 2D FT, waves traveling in different directions will have different signs in wavenumber. By separating components with different signs in wavenumbers, waves traveling in the different directions can be separated. In this case, waves traveling with increasing 505 or decreasing 510 distance of travel can be separated.

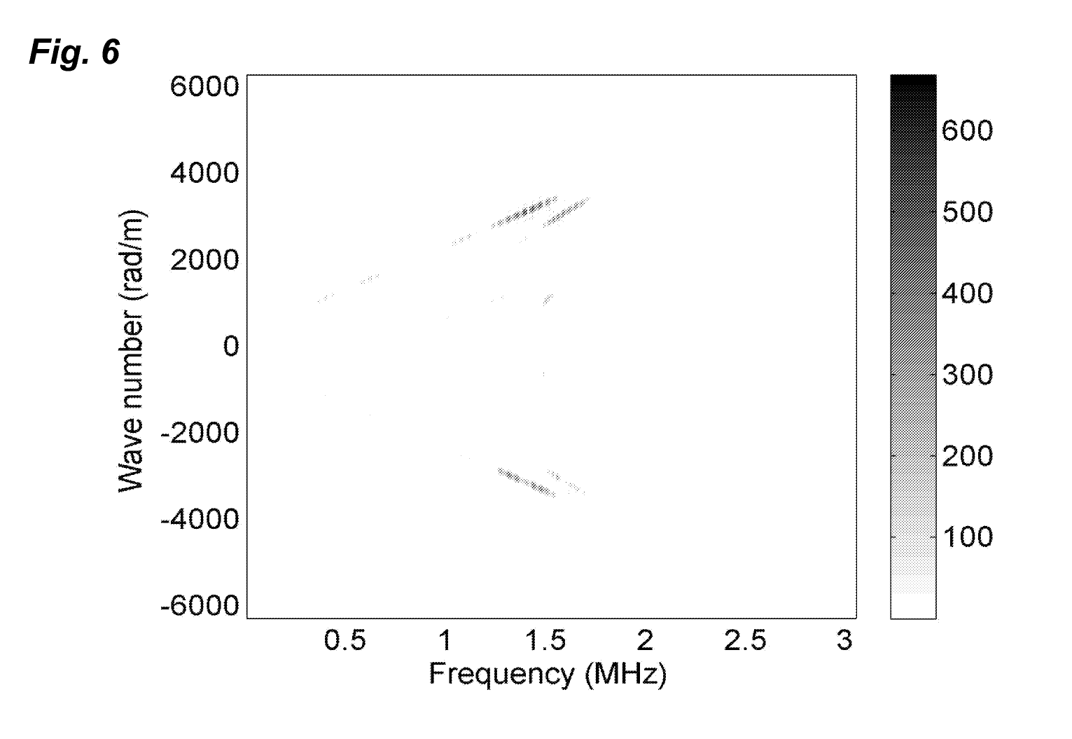

To illustrate this, the result of 2D FT of FIG. 5b is shown in FIG. 6 in which the X axis denotes frequency, the Y axis denotes wavenumber, and the brightness represents signal amplitude (the gray scale is reversed for the clarity of the graph). FIG. 6 shows the signals of FIG. 5b in k-ω domain in which four bright stripes can be seen. The image is basically symmetrical about the x axis. The image comprises four stripes, with two stripes centered on approximately 1.36 MHz at ±3141 rad/m and the other two centered on approximately 1.57 MHz at ±3141 rad/m. Not coincidentally, wavenumber 3141 rad/m corresponds to a wavelength of 2 mm. To apply k-ω domain filtering, the components with positive wavenumbers and negative wavenumbers can be filtered out separately and then returned to the space-time representation by taking the inverse 2D FT of the filtered signals.

The results are shown in FIG. 5c (positive slope) and 5d (negative slope). Compared with FIG. 5b, it is clear that the wave fronts with positive slopes 505 and negative slopes 510 have been separated successfully and the complexity of signals is greatly reduced. In addition, because the direct incident waves and reflection waves from the defect 410 have increasing distance of travel as the source 420 is moved away from the EMAT 415, FIG. 5c contains all the information necessary to calculate the reflection coefficients.

Laser generated ultrasonic signals are intrinsically non-stationary, non-periodic and broadband. Although Fourier transform is widely used to obtain frequency information in signals, it is not suitable for non-stationary signals due to the fact that it cannot retain time information. Unlike Fourier transform, however, different wavelet functions can be used in wavelet transforms depending on the application and signals of interest. This characteristic makes wavelet transforms flexible and powerful. Wavelet analysis can approximate a signal with shifted and scaled versions of a mother wavelet. Signals with sharp changes, for example, can be better analyzed with an irregular wavelet than with a smooth periodical sinusoid as used in Fourier analysis.

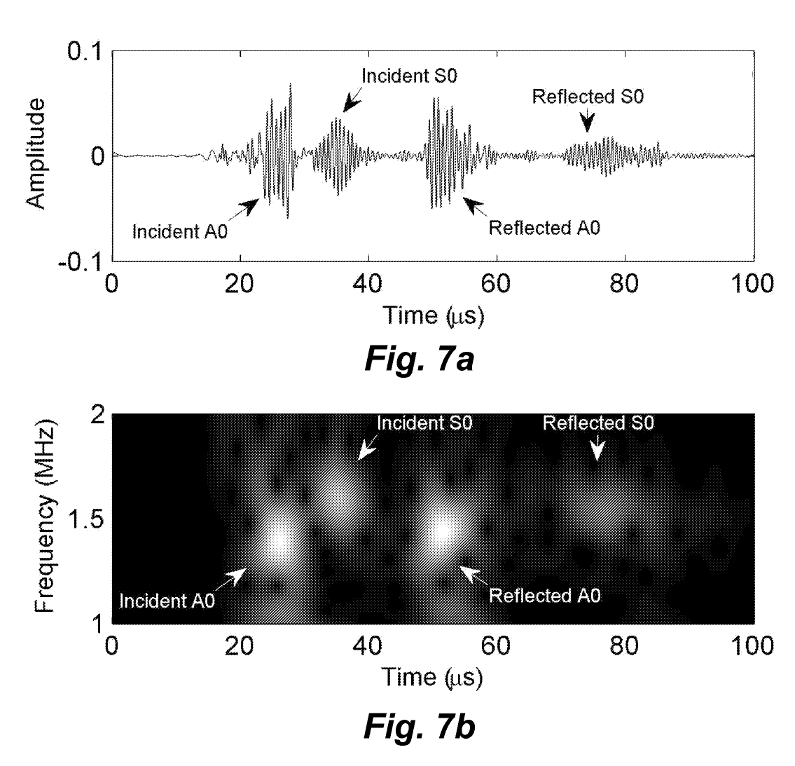

FIG. 7a shows the one time-domain signal of FIG. 5b when distance between source 420 and the EMAT 415 is 70 mm. From the time-domain signal, it can be difficult to identify the wave packets of different wave modes. Although some wave packets can be distinguished, others can overlap and interfere with each other in time. FIG. 7b, on the other hand, shows the time-frequency representation of the same signal in the frequency range 1 MHz to 2 MHz. The transformation is done using the complex Morlet mother wavelet. The complex Morlet mother wavelet can be defined as:

$$Ψ ( t ) = \frac{1}{\sqrt{π {f}_{b}}} exp ( 2 i π {f}_{c} t ) exp ( - \frac{{t}^{2}}{{f}_{b}} ) \qquad ( 5 )$$

where f_{b} is a bandwidth parameter and f_{c} is the wavelet center frequency. f_{b} and f_{c} are application and signal dependent which, in this case, can be chosen to be, for example, 10 and 1.5 MHz respectively. f_{c} is preferably chosen to be close to the frequency content of the signal that is of interest, e.g., the center frequency of the received signal f_{b} can be used to control the tradeoff between frequency and time resolution in the CWT.

By generating narrowband ultrasound signals, the frequency contents and propagating group velocities of different modes can be evaluated. And based on the geometry and the placement of the source 420, sensor 415, defect 410, and the dimension of the tested sample 405, the time of flight (TOF) of each wave can be calculated. By transforming the time domain signal into time-frequency representation, the wave packets can be more easily identified based on the TOF and frequency information. In FIG. 7b, for example, it is clear that there are two main frequency components in the signal. One is centered on approximately 1.36 MHz and the other is centered on approximately 1.57 MHz. Referring back to Table 1, these frequencies can be readily identified as the A₀ and S₀ modes respectively.

In addition, based on the TOF information, the originations of, for example, directed incident and reflected wave packets from the defect 410 can also be identified. In this example, the distance between the source 420 and EMAT 415 is 70 mm. According to Table 1, the group velocities of A₀ and S₀ are 3053.65 m/s and 2255.75 m/s, respectively. The TOF for direct incident waves of these two modes are 22.92 μs (i.e., 70 mm/3053.65 m/s) and 31.03 μs, respectively. Similarly, the distance of travel for a reflected wave packet from the defect is 154 mm so the TOF for reflected A₀ and S₀ from the defect are 50.43 μs and 68.27 μs respectively. As a result, the incident A₀, S₀ and reflected A₀, S₀ waves can be identified as labeled in FIG. 7b and the reflection coefficients can be calculated by the division of amplitudes of corresponding wave packets.

### Example 2

A set of finite element simulation on thin plates can be conducted to show that: (1) SLS has practical applications, and (2) the technique of k-ω filtering coupled with continuous wavelet transform can be used to correlate reflection coefficients to defect severity. To simplify problem at hand, the laser line sources are assumed to be infinitely long in the direction orthogonal to the plane defined by wave propagation and thickness. In this way, the problem can be reduced to a 2D plane strain problem. The material used in the simulation is aluminum with the material properties, i.e., longitudinal (C_{L}) and shear (C_{T}) wave speeds, listed in Table 2, below.

TABLE 2
Material Properties and Wave Speeds

| | E (GPa) | ν | λ (GPa) | μ (GPa) | C_{L} (m/s) | C_{T} (m/s) |
|---|---|---|---|---|---|---|
| Aluminum | 70 | 0.33 | 51.1 | 26.3 | 6194.4 | 3120.0 |

In some embodiments, the simulation of laser generated ultrasound can be approached as a sequentially solved transient thermo-mechanical problem. The temperature field induced by the laser input can first be solved and the temperature distribution can be taken as a thermal nodal load in the transient structural analysis in each time step. Then the transient displacement field can be solved sequentially. To perform this analysis, two different physical fields of analyses, which share the same geometry and the same mesh but with different element types, can be used. In a preferred embodiment, the element type used in thermal analysis is compatible with the element type used in structural analysis. Commercial software such as, for example and not limitation, Abaqus 6.8 can be used to perform this analysis.

Due to the large temperature gradient over a short period of time at the location where the laser illuminates the sample, fine mesh is preferred to capture an accurate transient temperature field. The element size needed for calculating accurate transient structural field (i.e., the area away from the laser in which the waves propagate), on the other hand is less demanding enabling the use of a coarser mesh. In a preferred embodiment, a smooth transition from the fine mesh to the coarse mesh is provided with a mesh size smaller than approximately one-sixth of the wavelength. In this example, therefore, a mesh size of 100 μm is used in the wave propagation region and a mesh size of 5 μm is used in the laser input region.

In some embodiments, two time steps can be used in the analysis, the laser-on stage and the laser-off stage. During the heat input (i.e., laser irradiating) stage, the time step is set to a small interval (e.g., 1 ns in this example) to capture the rapid change of temperature distribution from the laser. Afterwards, the time step can be set to a larger interval (e.g., 25 ns) for the remainder of the analysis. In some embodiments, the appropriate time step can be chosen to correspond to the time the fastest possible wave propagates between successive elements in the mesh. In this configuration, the fastest wave is a longitudinal wave with a speed of approximately 6000 m/s, thus the choice of 25 ns is appropriate.

The thermal loading condition in the simulation can be described as follows:

$$- k \frac{\partial T ( x , y , t )}{\partial y} {\vert}_{top \_ surface} = {I}_{0} A ( T ) f ( x ) g ( t ) \qquad ( 6 )$$

where k is the thermal conductivity, I₀ is the incident laser energy density, the total energy is set to be 46 mJ (i.e., the setting used in this example), and A(T) is the optical absorptivity of the specimen surface. For aluminum, the optical absorptivity is as follows, where T is in Celsius.

A(T)=5.2×10⁻²+3×10⁻⁵(T−27) (7)

f(x) and g(t) are the spatial and temporal distributions of the laser pulse, respectively. These two functions can be written as:

$$\begin{matrix}f ( x ) = exp ( - \frac{{x}^{2}}{{x}_{0}^{2}} ) & ( 8 ) \\ g ( t ) = \frac{t}{{t}_{0}} exp ( - \frac{t}{{t}_{0}} ) & ( 9 )\end{matrix}$$

where x₀ and t₀ are set to be 300 μm and 10 ns, respectively, in this example.

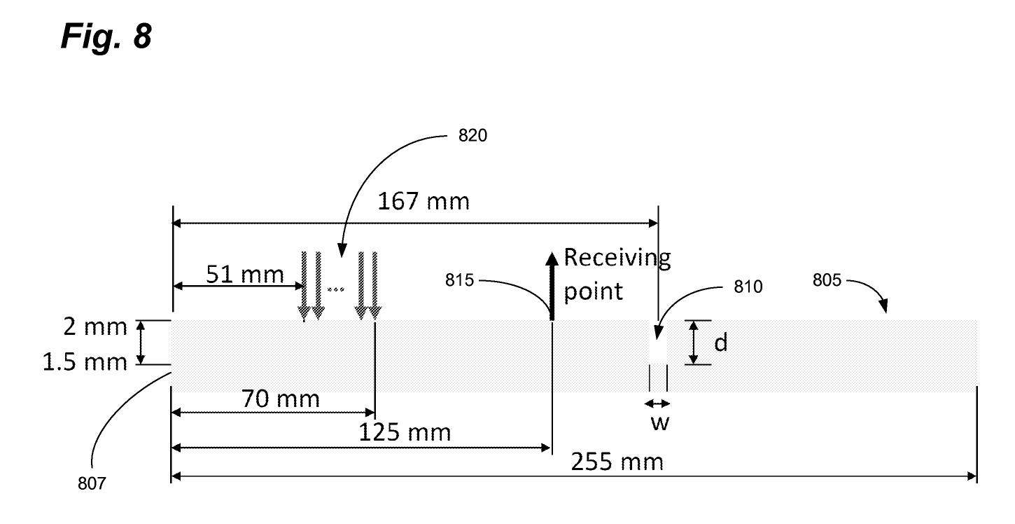

The experimental setup for this example is shown in FIG. 8. The length of the plate 805 is 255 mm and the thickness is either 1.5 mm or 2 mm. A surface breaking notch 810 is located 167 mm away from the left end 807 of the plate 805. The width, w, of the notch 810 is 0.8 mm and the depth, d, is increased from ⅛ of the plate thickness to ⅞ of the plate thickness in increments of ⅛ of the thickness of the plate.

The receiving point 815 is located 125 mm away from the left side 807 of the plate 805. For a given notch depth, ultrasonic signals are generated separately by 20 single line sources 820 located between 51 mm and 70 mm away from the left end 807 of the plate 805 in 0.5 mm intervals. As before, wavenumber-frequency domain filtering can be performed on these signals to separate ultrasounds propagating in different directions. After the ultrasonic signals are simplified, narrowband signals corresponding to 2 mm and 3 mm wavelengths can be created by superimposing every five signals together.

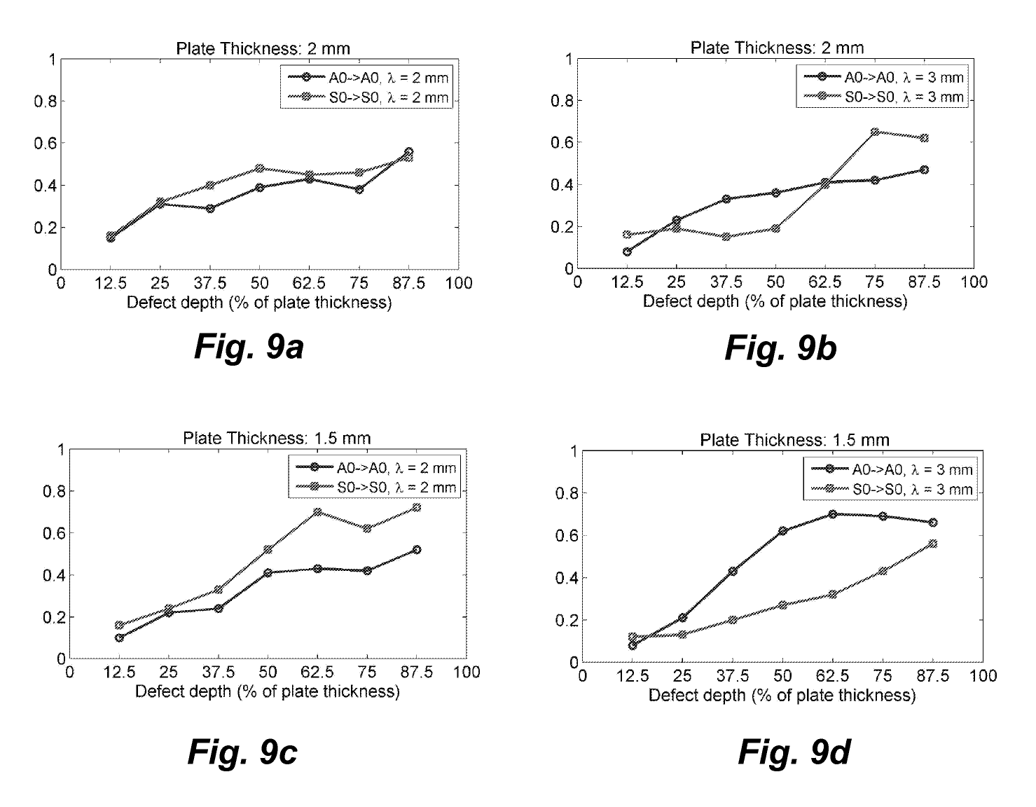

The narrowband signals can then be processed by the above mentioned techniques to identify the wave packets induced by different sources. The reflection coefficients due to the notches can be calculated by dividing the amplitudes of the reflected waves by those of incident waves. The simulation results are shown in FIGS. 9a-9d.

### Example 3

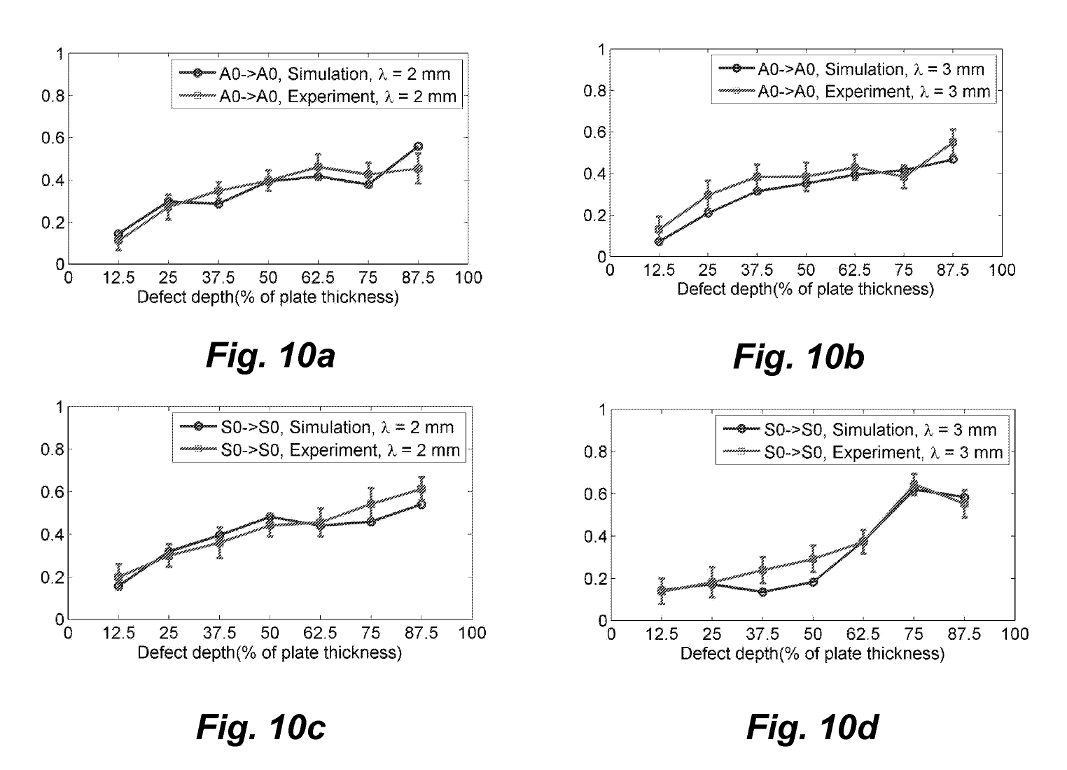

To validate the simulation results, a set of experiments can be conducted. The experimental setup can be the same as the setup depicted in FIG. 4 and the testing procedure can be substantially the same as the procedure previously described. See, “Signal Processing Procedure” section, above. On each sample, an artificial groove is made to simulate a surface breaking defect. In the example, the plate thickness is 2 mm and the grooves are 0.8 mm wide and vary in depth. Seven depths are used in these experiments: 0.25, 0.50, 0.75, 1.00, 1.25, 1.50, and 1.75 mm (i.e., ⅛, 2/8, ⅜, 4/8, ⅝, 6/8 and ⅞ of the plate thickness). A set of five signals that correspond to 2 mm or 3 mm wavelength are superimposed and then processed using the signal processing procedure discussed earlier. Reflection coefficients can then be calculated and compared with simulation results. The results and comparison are shown in FIGS. 10a-10d.

### Discussion of Simulation and Experimental Results

In FIGS. 9a-9d, the simulation results of the reflection coefficients of modes A₀ and S₀ with different plate thicknesses and wavelengths are presented. In the figures, the legend “A₀->A₀” denotes the coefficients corresponding to incident A₀ mode and reflected A₀ mode and the legend “S₀->S₀” denotes the coefficients corresponding to incident S₀ mode and reflected S₀ mode. As expected, the strength of the reflection coefficients increases with the severity of the defects, however, most of them do not increase monotonically.

In FIG. 9a, for example, with a plate thickness of 2 mm, the reflection coefficients for A₀ mode and S₀ mode with a 2 mm wavelength are very similar and the frequency-thickness (f-d) product of A₀ mode and S₀ mode (using the data from Table 1) are 2720 (i.e., 1.36 MHz×2 mm) and 3140 Hz-m (i.e., 1.57 MHz×2 mm), respectively. Most parts of the reflection coefficients for both cases are between 0.2 and 0.6. In contrast, in FIG. 9b, the reflection coefficient curves of A₀ mode and S₀ mode with 3 mm wavelength are very different. The f-d product of A₀ mode and S₀ mode, for example, are 1700 and 2480 Hz-m, respectively. For A₀ mode, the coefficients gradually rise with the defect depth. The substantially linear response between the 3 mm A₀ mode in a 2 mm plate makes it suitable for use as a calibration curve for quantifying defect depth. For S₀ mode, the coefficients are basically constant around 0.2 when the defect depth is below 50% of the plate thickness. This is an unexpected result because the symmetric modes would generally be expected to be more sensitive to asymmetric defects in a plate. One possible explanation is that the energy is reflected in the form of mode conversion, which cannot be measured using the SLS technique.

FIGS. 9c and 9d show reflection coefficients when the plate thickness is 1.5 mm. The f-d product of a 2 mm wavelength λ₀ mode and S₀ mode are 2325 and 2880 Hz-m, respectively. The f-d product of 3 mm wavelength A₀ mode and S₀ mode are 1455 and 2325 Hz-m respectively. The profile of reflection coefficients for A₀ mode with 2 mm wavelength shows substantial similarity with the above results from a plate thickness of 2 mm. For 3 mm wavelength, on the other hand, the reflection coefficient of S₀ mode increases steadily with defect depth, but the A₀ mode levels off when the defect depth is greater than approximately 50% of the plate.

FIGS. 10a-10d shows the comparison between the simulation and experimental results with a 2 mm plate thickness. As shown, there is good correlation between the experimental results and the simulation. Based on the simulation and experimental results, the sensitivities of reflection coefficients to defect depth are quite different in different situations. When the plate thickness is 2 mm and the wavelength is 3 mm, for example, the reflection coefficient of S₀ appears substantially insensitive to the shallow defects (i.e., when the depth is less than 1 mm). Under the same conditions, the reflection coefficient of A₀, on the other hand, appears substantially insensitive to the defect depths in the middle range (i.e., between 37.5% and 75% of the plate thickness).

Embodiments of the present invention relate to a technique for creating laser generated, narrowband ultrasound. The SLS technique discussed herein can generate narrowband ultrasonic signals while retaining the non-contact benefits of laser generation. The technique is mathematically equivalent to the pattern source technique, yet permits the flexibility of selecting desired propagating wavelength after all signals have been stored in computer memory. By generating narrowband ultrasound, the frequency contents and travelling speeds of different wave modes can be determined through dispersion curves. Combined with continuous wavelet transforms and wavenumber-frequency domain filtering, the source of each wave packet can be readily identified. The reflection coefficients can be obtained by dividing amplitudes between corresponding wave packets in the time-frequency domain.

The simulation and experimental results show strong agreement, and demonstrate the potential of this technique in, for example and not limitation, non-destructive testing applications. While several possible embodiments are disclosed above, including on-line real-time NDT in industrial settings, embodiments of the present invention are not so limited. For instance, while several possible configurations have been disclosed, other suitable materials and combinations of materials could be selected without departing from the spirit of embodiments of the invention. In addition, the location and configuration used for various features and components of embodiments of the present invention can be varied according to a particular material, sample size, or setting that requires a slight variation due to, for example, surrounding machinery (e.g., on an assembly line) or other space and/or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

We claim:

1. A system for generating narrow band Lamb waves in a sample comprising:
a concentrated, non-contact energy source for creating localized heating in the sample to cause ultrasonic waves;
an ultrasound receiver for receiving the ultrasonic waves;
a linear stage for moving the sample at a predetermined step interval; and
a computer readable medium for storing one or more signals generated by the ultrasound receiver.

2. The system of claim 1, wherein the concentrated energy source is a pulse width laser.

3. The system of claim 2, further comprising a cylindrical lens for converting the concentrated energy from the pulsed width laser into a line source pattern.

4. The system of claim 1, wherein the concentrated energy source is an electromagnetic acoustic transceiver (“EMAT”).

5. The system of claim 1, wherein the ultrasound receiver is an EMAT.

6. The system of claim 1, wherein the ultrasound receiver is a laser interferometer.

7. The system of claim 1, further comprising a computer processor for superimposing the one or more signals generated by the ultrasound receiver to improve the signal-to-noise ratio, reduce the signal complexity, or both.

8. The system of claim 7, wherein the computer processor further reduces the complexity of the one or more signals using a two-dimensional Fourier transform.

9. The system of claim 7, wherein the computer processor further reduces the complexity of the one or more signals using a continuous wavelet transform.

10. A method for generating narrow band Lamb waves in a sample comprising:
(1) activating a pulsed, concentrated energy source to create ultrasonic waves in the sample;
(2) receiving the ultrasonic waves with an ultrasound receiver;
(3) storing a first signal generated by the ultrasound receiver on a computer readable medium;
(4) moving the sample a first predetermined distance; and
repeating steps 1-4 until the sample has moved a second predetermined distance.

11. The method of claim 10, further comprising:
retrieving a first plurality of signals stored on the computer readable medium from the ultrasonic receiver; and
superimposing a second plurality of signals that correspond to a first wavelength to create a first artificial narrowband ultrasound source; and
storing the first artificial narrowband ultrasound source on the computer readable medium.

12. The method of claim 11, further comprising:
retrieving the first artificial narrowband ultrasound source from the computer readable medium;
reducing the complexity of the first artificial narrowband ultrasound source using a two-dimensional Fourier transform to create a second artificial narrowband ultrasound source with reduced complexity; and
storing the second artificial narrowband ultrasound source on the computer readable medium.

13. The method of claim 12, further comprising:
retrieving the second artificial narrowband ultrasound source from the computer readable medium;
reducing the complexity of the second narrowband ultrasound source using a continuous wavelet transform to create a third artificial narrowband ultrasound source with reduced complexity; and
storing the third artificial narrowband ultrasound source on the computer readable medium.

14. The method of claim 13, wherein the continuous wavelet transform is a complex Morlet mother wavelet.

15. The method of claim 10, wherein the first predetermined distance is smaller than the first wavelength.

16. The method of claim 10, wherein the pulsed, concentrated energy source is a radio frequency generator.
